(19) United States
(12) Patent Application Publication
(10) Pub. No.: US 2022/0253696 A1
(43) Pub. Date: Aug. 11, 2022

(54) INTERPRETABLE TIME SERIES REPRESENTATION LEARNING WITH MULTIPLE-LEVEL DISENTANGLEMENT

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Yuening Li, College Station, TX (US)

(21) Appl. No.: 17/582,191

(22) Filed: Jan. 24, 2022

Related U.S. Application Data
(60) Provisional application No. 63/144,077, filed on Feb. 1, 2021.

(51) Int. Cl. G06N 3/08; G06N 3/04

(52) U.S. Cl. CPC G06N 3/08; G06N 3/0445

(57) ABSTRACT

A method for employing a deep unsupervised generative approach for disentangled factor learning is presented. The method includes decomposing, via an individual factor disentanglement component, latent variables into independent factors having different semantic meaning, enriching, via a group segment disentanglement component, group-level semantic meaning of sequential data by grouping the sequential data into a batch of segments, and generating hierarchical semantic concepts as interpretable and disentangled representations of time series data.

### RELATED APPLICATION INFORMATION

This application claims priority to Provisional Application No. 63/144,077, filed on Feb. 1, 2021, the contents of which are incorporated herein by reference in their entirety.

### BACKGROUND

### Technical Field

The present invention relates to representation learning and, more particularly, to interpretable time series representation learning with multiple-level disentanglement.

### Description of the Related Art

Representation learning is a fundamental task for time series analysis. While promising progress has been made toward learning efficient representations for downstream applications, the learned representations often lack interpretability and do not encode semantic meanings by the complex interactions of many latent factors. Learning representations that disentangle these latent factors can bring semantic-rich representations of time series and further enhance interpretability. This task is challenging since directly adopting the sequential models, such as recurrent variational autoencoders (LSTM-VAE), often faces a Kullback-Leibler (KL) vanishing problem, that is, the long short-term memory (LSTM) decoder often generates sequential data without efficiently using latent representations, and the latent spaces sometimes could even be independent of the observation space. This phenomenon is caused by the KL divergence term collapsing to zero when directly optimizing variational autoencoders (VAE) for sequential data. Thus, the mutual information between the latent space and the inputs becomes vanishingly small. As a result, directly disentangling the latent representation is meaningless as the latent variables are independent of the input.

### SUMMARY

A method for employing a deep unsupervised generative approach for disentangled factor learning is presented. The method includes decomposing, via an individual factor disentanglement component, latent variables into independent factors having different semantic meaning, enriching, via a group segment disentanglement component, group-level semantic meaning of sequential data by grouping the sequential data into a batch of segments, and generating hierarchical semantic concepts as interpretable and disentangled representations of time series data.

A non-transitory computer-readable storage medium comprising a computer-readable program for employing a deep unsupervised generative approach for disentangled factor learning is presented. The computer-readable program when executed on a computer causes the computer to perform the steps of decomposing, via an individual factor disentanglement component, latent variables into independent factors having different semantic meaning, enriching, via a group segment disentanglement component, group-level semantic meaning of sequential data by grouping the sequential data into a batch of segments, and generating hierarchical semantic concepts as interpretable and disentangled representations of time series data.

A system for employing a deep unsupervised generative approach for disentangled factor learning is presented. The system includes a memory and one or more processors in communication with the memory configured to decompose, via an individual factor disentanglement component, latent variables into independent factors having different semantic meaning, enrich, via a group segment disentanglement component, group-level semantic meaning of sequential data by grouping the sequential data into a batch of segments, and generate hierarchical semantic concepts as interpretable and disentangled representations of time series data.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary disentangle time series (DTS) architecture for learning semantically interpretable time series representations, in accordance with embodiments of the present invention;

FIG. 2 is a block/flow diagram of an exemplary structure of the individual factor disentanglement, in accordance with embodiments of the present invention;

FIG. 3 is a block/flow diagram of an exemplary structure of the group segment disentanglement, in accordance with embodiments of the present invention;

FIG. 4 is a block/flow diagram of an exemplary schematic illustrating multi-level disentangled time-series representation learning including individual factor disentangle and group segment disentangle, in accordance with embodiments of the present invention;

FIG. 5 is a block/flow diagram of exemplary equations for employing a deep unsupervised generative approach for disentangled factor learning, in accordance with embodiments of the present invention;

FIG. 6 is a block/flow diagram of an exemplary practical application for employing a deep unsupervised generative approach for disentangled factor learning, in accordance with embodiments of the present invention;

FIG. 7 is a block/flow diagram of exemplary Internet-of-Things (IoT) sensors used to collect data/information for employing a deep unsupervised generative approach for disentangled factor learning, in accordance with embodiments of the present invention.

FIG. 8 is an exemplary practical application for employing a deep unsupervised generative approach for disentangled factor learning, in accordance with embodiments of the present invention;

FIG. 9 is an exemplary processing system for employing a deep unsupervised generative approach for disentangled factor learning, in accordance with embodiments of the present invention; and

FIG. 10 is a block/flow diagram of an exemplary method for employing a deep unsupervised generative approach for disentangled factor learning, in accordance with embodiments of the present invention.

### DETAILED DESCRIPTION OF PREFERRED EMBODIMENTS

Unsupervised representation learning, as a fundamental task of time series analysis, aims to extract low-dimensional representations from complex raw time series without human supervision. Recently, deep generative models have shown great representation ability in modeling complex underlying distributions of time series data. The most representative ones include the long short-term memory variational autoencoder (LSTM-VAE) and its variants.

While these representation learning techniques can achieve good performance in many downstream applications, the learned representations often lack the interpretability to expose tangible semantic meanings. In many cases, especially in high-stakes domains, an interpretable representation is important for diagnosis or decision-making. For example, learning interpretable and semantic-rich representations can help decompose the electrocardiogram (ECG) into cardiac cycles with recognizable phases as independent factors. Furthermore, extracting and analyzing common sequential patterns (e.g., normal sinus rhythms) from massive ECG records can assist clinicians with better understanding of irregular symptoms. In contrast, diagnostic processes without transparency or accurate explanations may lead to suboptimal or even risky treatments.

To extract semantically meaningful representations, researchers in computer vision have turned to disentanglement learning, which decomposes the representations into subspaces and encodes them as separate dimensions. A disentangled representation can be defined as one where single latent units are sensitive to changes in a single latent factor while being relatively invariant to changes in other factors. Different dimensions in the latent space are probabilistically independent. Learning factors of variations in the images reveals semantic meanings in the underlying distribution.

Motivated by the success of disentanglement in the image domain, the exemplary methods explore disentangled representations for time series. The learned semantic factor can control the shape of ECG time series. Medically, inverted, biphasic, or flattened T wave, as one exemplary sequential pattern, can provide insights into the abnormalities of the ventricular repolarization ventricular depolarization. In addition, the QT interval, as a group of individual patterns from the beginning of the Q wave to the end of the T wave, can represent the physiologic reactions for the ventricles of the heart to de-polarize and re-polarize. Thus, there exists a need for methods that can enhance the interpretability of time series representations from the perspective of both single factor and group-level factor disentanglement.

However, disentangled representation learning in time series settings presents several unique challenges. Firstly, temporal correlations make the latent representations hard to interpret. Time series data usually include temporal correlations, which cannot be directly captured and interpreted by traditional image-focused disentanglement methods. While traditional sequential models, like LSTM or LSTM-VAE, could be used to model the temporal correlations, they neither provide interpretable predictions, nor have a disentanglement mechanism. Secondly, naively applying disentanglement methods to sequential models may intensify the KL vanishing problem. When compounded with strong autoregressive decoders, VAE-based sequential models often converge to a degenerated local optimum known as “Kullback—Leibler (KL) vanishing,” which causes the latent variables to be relatively independent of the observations. Unfortunately, traditional disentanglement methods may intensify the trend of KL vanishing along with the disentanglement process because they tend to penalize the mutual information between the latent space and the observations. Thirdly, interpretable semantic concepts often rely on multiple factors instead of individuals. A human-understandable sequential pattern, called a semantic component, is usually correlated with multiple factors.

To address these challenges, the exemplary methods introduce a Disentangle Time Series (DTS) architecture for learning semantically interpretable time series representations. DTS is the first attempt to incorporate disentanglement strategies for time series. In particular, the exemplary methods design a multi-level time series disentanglement strategy that accounts for both individual factors and group-level segments to generate hierarchical semantic concepts as the interpretable and disentangled representations of time series. To disentangle individual latent factors, DTS augments the original training objective by decomposing the evidence lower bound. In this way, the augmented objective can preserve the disentanglement property and alleviate the KL vanishing problem simultaneously or concurrently.

The exemplary methods also introduce another mutual information maximization term to preserve the correlation between the latent variables and the original time series. The exemplary methods theoretically prove that the new objective can balance the preference between correct inference and fitting data distribution. To disentangle individual latent factors, DTS adjusts the training objective from two aspects, that is, augmenting the original training objective by decomposing the evidence lower bound, which aims to preserve the disentanglement property and alleviate the KL vanishing problem simultaneously and by introducing a mutual information maximization term, which aims to preserve the correlation between the latent variables and the original time series. In addition, the exemplary methods theoretically prove that the new objective can balance the preference between correct inference and fitting data distribution. To disentangle group-level semantic segments, DTS learns to decompose time series into independent semantic segments, and each of them includes batches of independent latent variables. The exemplary methods only utilize the segments with target task-relevant information to eliminate negative transfer from incidentally encoded irrelevant information.

The advantages of the present invention include at least introducing DTS to incorporate disentanglement strategies for time series representation learning. The exemplary methods further advantageously propose a multi-level time series disentanglement strategy, covering both individual latent factor and group-level semantic segments to generate hierarchical semantic concepts as the interpretable and disentangled representation of time series. The exemplary methods also advantageously introduce an evidence lower bound decomposition strategy that could balance the preference between correct inference and data distribution fitting. The exemplary methods advantageously show how to preserve the correlation between the latent space and inputs and factorize the latent space for disentanglement simultaneously or concurrently.

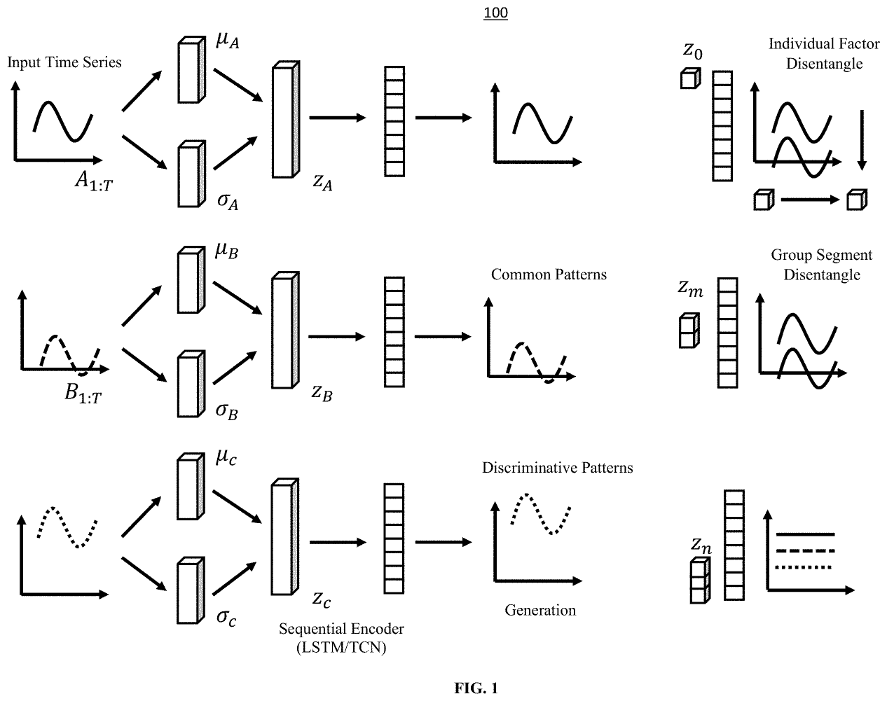

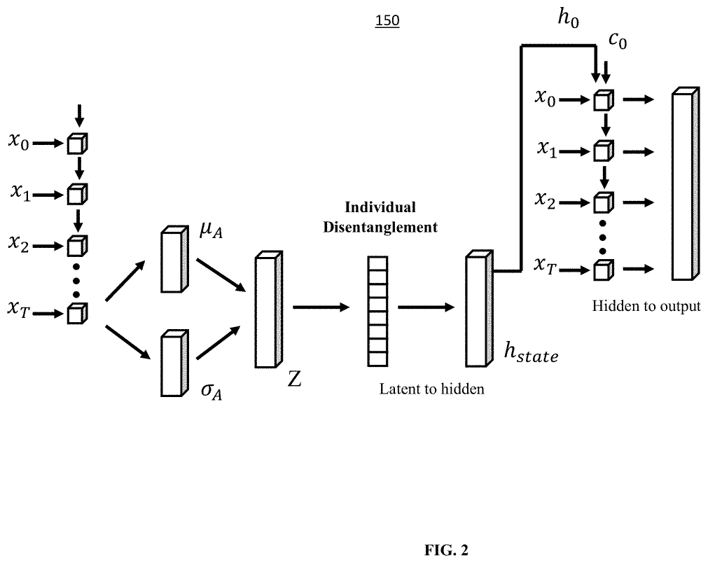

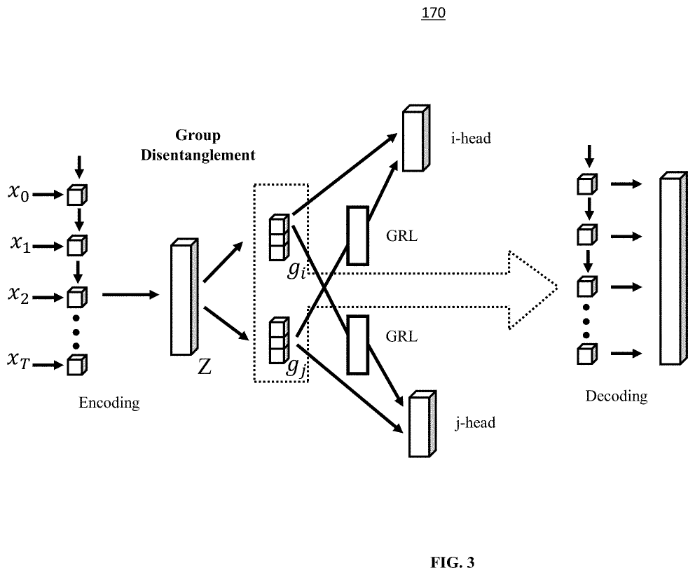

DTS is a multi-level disentanglement approach (e.g., the disentanglement enforcement framework or architecture 100 of FIG. 1) to enhance time series representation learning. DTS factorizes the latent space as independent semantic concepts. DTS includes Individual Factor Disentanglement structure 150 (FIG. 2) and Group Segment Disentanglement structure 170 (FIG. 3). The individual factor disentanglement structure 150 decomposes the latent variables into independent factors that contain different semantic meanings, while the group segment disentanglement structure 170 aims to enrich the group-level semantic meaning of sequential data by grouping them into a batch of segments. To achieve the multi-level disentanglement, an evidence lower bound (ELBO) decomposition strategy is proposed to find evidence linking factorial representations to disentanglement without sacrificing the correct inference.

Regarding notations, let x=[x₁, x₂, . . . , x_{T}] ∈ [symbol] ^{T} be a time series of length T, which is associated with a latent representation z=[z₁, z₂, . . . , zₙ] ∈ [symbol] ⁿ. Each entry zᵢ is a value of a latent variable, which is a disentangled factor that describes a particular sequential pattern of x. The set Zₛ=z₁, z₂, . . . , zₙ includes all of the factors. As some complex patterns may only be described by a sub-group of factors from Zₛ, the exemplary methods use Z_{g}=g₁, . . . , gₘ to denote a division of Zₛ, where gᵢ includes several latent variables from Zₛ, e.g., gᵢ ⊂ Zₛ, and the sub-groups are disjoint, e.g., gᵢ ∩ gⱼ=∅, ∀1≤i, j ≤m and m≤n.

Specifically, a disentangled factor zᵢ should be sensitive to the changes in a single semantic concept that governs the generation of the time series, while being invariant to the changes caused by other latent variables in Zₛ. For example, one latent variable controls the shape of the time series in one interval but will not cause the changes of other intervals (which could be controlled by other latent variables). The disentanglement between factors is denoted by zᵢ [symbol] zⱼ. Similarly, two groups of factors are disentangled, e.g., gᵢ [symbol] gⱼ, if they are invariant to the changes of the other's corresponding sequential patterns.

Given a training dataset [symbol] ={x}, the goal is to solve a multi-level time series disentanglement problem, by learning a set of latent variables Zₓ={z₁, z₂, . . . , zₙ}, where zᵢ [symbol] zⱼ, ∀1≤i, j≤n, and a division of latent variables Z_{g} ={g₁, . . . , gₘ}, where gᵢ [symbol] gⱼ, ∀1≤i, j≤m, such that the latent representation z of each time series x is semantically meaningful.

First, the exemplary methods introduce how disentanglement is achieved for static data from a generative modeling perspective. A latent variable generative model defines a joint distribution between a feature space Z ∈ Z, and the observation space x ∈ X. Suppose p(Z) is a prior distribution of the latent variables, and p_{θ}(x|Z) is a conditional probability of x that is parameterized by neural networks θ (e.g., RNNs), then the disentanglement goal is to maximize the marginal likelihood of the observed samples in the training dataset:

[symbol]

₍ₓ₎ [log p_{θ}(x)]= [symbol] ₍ₓ₎ [log [symbol] _{p(Z)} [p_{θ}(x|Z)]] (1)

Where p_{D}(x) represents the true underlying distribution, which can be estimated using the training dataset.

However, exact posterior inference of equation (1) is analytically intractable, due to the integration:

[symbol]

_{p(Z)} [p_{θ}(x|Z)]=∫_{z}p_{θ}(x|Z)p(Z)dz

over latent variables.

Therefore, similar to a variational inference, an amortized inference distribution q_{ϕ}(Z|x) is introduced to approximate the posterior with learnable parameters ϕ, and a lower bound (ELBO) of equation (1) can be derived as:

[symbol]

_{ELBO}(x)=−D_{KL}(q_{ϕ}(Z|x)∥p(Z))+ [symbol] _{q}_{_{ϕ}}_{(Z|x)} [log p_{θ}(x|Z)] (2)

To learn disentangled representations, β−VAE has been introduced as an effective solution. It is a variant of the variational autoencoder that attempts to learn a disentangled representation by optimizing a heavily penalized objective with β>1.

[symbol]

_{β-ELBO}(x)=−βD_{KL}(q_{ϕ}(Z|x)∥p(Z))+ [symbol] _{q}_{_{ϕ}}_{(Z|x)} [log p_{θ}(x|Z)] (3)

The penalization enables disentangled effects of models on image datasets. The β constraint imposes a limit on the capacity of the latent information channel and controls the emphasis on learning statistically independent latent factors. With increasing β, the latent variables become more disentangled as the distributions in the latent space deviate from each other by fitting the marginal Gaussian distribution more than the KL divergence. Thus, semantically similar observations move closely, resulting in clusters corresponding to underlying factors of variation, which facilitate interpretation.

To model sequential data, the autoregressive decoder is often used with VAE, such as LSTM-VAE, for time series analysis. However, when compounded with strong autoregressive decoders such as LSTMs, VAE suffers from an issue known as posterior collapse or KL vanishing. The decoder in VAE reconstructs the data independently of the latent variables, and the KL term vanishes to 0. This is because the reconstruction term in the objective will dominate the KL divergence term during the training phase. As a result, the model generates time series without making effective use of the latent variables.

Specifically, in equation (3), the latent variables Z become independent from observations x, when the KL divergence term collapses to zero. Thus, the latent variable Z cannot serve as an effective representation for the input x, which is also known as the information preference problem. In this case, pushing Gaussian clouds away from each dimension in the latent space to encourage disentangling latent factors becomes meaningless if latent distributions are independent and unhooked with the observation space.

Regarding individual factor disentanglement, to alleviate the KL vanishing problem and preserve the disentanglement property, the exemplary methods decompose the evidence lower bound (ELBO) and explain the causes of the KL vanishing problem and disentanglement. The exemplary methods introduce a mutual information maximization term to the ELBO decomposition, which enables better representation Z that captures the semantic characteristics of the input x.

Regarding ELBO TC-Decomposition, to understand the internal mechanism of the disentanglement, the exemplary embodiments decompose the ELBO to find evidence linking factorial representations to disentanglement. By decomposing the ELB 0 into separate components, the exemplary methods can have a new perspective for the reason of the KL vanishing problem, that is, by introducing a heavier penalty on the ELBO tends to encourage the independence between latent variables but neglects the mutual information between the latent variables and the input.

The exemplary methods define q_{ϕ}(Z, x)=q_{ϕ}(Z|x)p_{θ}(x).

q_{ϕ}(Z) is denoted as: q_{ϕ}(Z)= [symbol] ₚ_{_{θ(x)}}q(z|x) as the aggregated posterior, which captures the aggregate structure of the latent variables under the data distribution of the p_{θ}(x).

Mathematically, the KL term in equations (2) and (3) can be decomposed with a factorized p(Z).

$${D}_{KL} ( {q}_{ϕ} ( Z \vert x ) ‖ p ( Z ) ) = \underbrace{KL ( {q}_{ϕ} ( Z , x ) ‖ {q}_{ϕ} ( Z ) {p}_{θ} ( x ) )}_{( i ) Index - Code MI} + \underbrace{KL ( {q}_{ϕ} ( Z ) ‖ {Π}_{j} {q}_{ϕ} ( {z}_{j} ) )}_{( ii ) Total Correlation} + \underbrace{{\sum }_{j} KL ( {q}_{ϕ} ( {z}_{j} ) ‖ p ( {z}_{j} ) )}_{( iii ) Dimension - wise KL} \qquad ( 4 )$$

where zⱼ denotes the jth dimensions of the latent variable.

The first term can be interpreted as the index-code mutual information (MI) I_{qϕ}(Z; x), which is the MI between the data variable and latent variable. The second term is referred to as the total correlation (TC), which acts as a generalization of MI to more than two random variables. TC also evaluates the dependency between the variables. The penalty on TC encourages statistically independent factors in the data distribution. A heavier penalty on this term induces a more disentangled representation. This term explains the success of β−VAE . Recent works indicate TC is the most important term in this decomposition for learning disentangled representations by only penalizing this term. The last term is the dimension-wise KL, which prevents individual latent dimensions from deviating too far away from their priors. It serves as a complexity penalty on the aggregate posterior, according to the minimum description length formulation of the ELBO.

Increasing the may β intensify the MI vanishing problem. Along with optimizing the ELBO, when the model has a better quality of disentanglement within the learned latent representations, it penalizes the MI simultaneously. It can, in turn, lead to under-fitting or ignoring the latent variables. The approximate inference distribution is often significantly different from the true posterior. This is undesirable because a goal of unsupervised learning is to learn meaningful latent features that should depend on the observations. Thus, the ELBO objective favors fitting the data distribution over performing correct amortized inference. When the two goals are conflicting, the ELBO objective tends to sacrifice the correct inference to better fit (or worse overfit) training data, which is referred to as the information preference problem.

Regarding ELBO DTS-Decomposition, to address the information preference problem, the exemplary methods propose an ELBO decomposition strategy by explicitly maximizing the MI between the latent space and the input. In this way, the exemplary methods can disentangle the latent space without sacrificing the correct inference.

Specifically, as discussed before, the latent variable Z becomes independent from observations x. To encourage the model to use the latent variables, an MI maximization term is added, which encourages a high MI between x and Z. In other words, the exemplary methods can address the information preference problem by balancing the preference between correct inference and fitting data.

Beginning from the ELBO in LSTM-VAE (in equation (2)), the exemplary methods arrive at:

−D_{KL}(q_{ϕ}(Z|x)∥p(Z))+ [symbol] _{q}_{_{ϕ}}_{(Z|x)} [log p_{θ}(x|Z)] (5)

where I_{q}_{_{ϕ}}(x; Z), denotes the MI between x and Z under the distribution q_{ϕ}(x; Z).

But the objective cannot be directly optimized.

Thus, it is rewritten into another equivalent form:

−D_{KL}(q_{ϕ}(Z|x)∥p(Z))+αD_{KL}(q_{ϕ}(Z)∥p(Z))+ [symbol] _{q}_{_{ϕ}}_{(Z|x)} [log p_{θ}(x|Z)] (6)

The MI maximization term (the second part of Eq. 6) plays the same role as the first term in the ELBO-TC decomposition (as shown in Eq. 4), but the optimization directions are contrary. Thus, increasing the disentanglement degree may intensify the KL vanishing problem, and vice versa. To enforce the model to preserve the disentanglement property while alleviating the KL vanishing, the MI regularizer term is combined with the ELBO-TC decomposition in equation (4) and the MI maximization term is merged.

Then the ELBO can be re-written as:

$${ℒ}_{ELBO} ( x ) = - β {D}_{KL} ( q ( Z ) ‖ {\prod }_{j} q ( {z}_{j} ) ) - β {\sum }_{j} {D}_{KL} ( q ( {z}_{j} ) ‖ p ( {z}_{j} ) ) + ( α - β ) {D}_{KL} ( {q}_{ϕ} ( Z ) ‖ p ( Z ) ) + {𝔼}_{{q}_{ϕ} ( Z \vert x )} [ log {p}_{θ} ( x \vert Z ) ] , \qquad ( 7 )$$

where x is an input time series, β is a constraint, Z is a latent variable, zⱼ is a value of a latent variable, p_{θ}(x|Z) is a conditional probability of x that is parameterized by neural networks θ, q_{ϕ}(Z)= [symbol] ₚ_{_{θ(x)}}q(z|x) is an aggregated posterior, D_{KL} is a decomposed KL term, α is a parameter that controls an importance of the dependency between z and x, q(zⱼ) is a factorized posterior that captures an aggregate structure of the latent variables, p(zⱼ) is a factorized prior distribution, p(Z) is a prior distribution, and q(Z) is the aggregated posterior that captures an aggregate structure of the latent variables.

Mathematically, the exemplary methods alleviate the KL vanishing problem by introducing the MI maximization term, while preserving a heavier penalty (when β>1) on the total correlation and the dimension-wise KL to keep the disentanglement property.

Regarding group segment disentanglement, by employing the aforementioned ELBO DTS-Decomposition, the exemplary methods can achieve individual factor disentanglement. However, the capacity of one single factor is often not sufficient to represent complex concepts. Thus, the exemplary methods generalize individual disentanglement to group segment disentanglement to further enrich the latent factor representations.

FIG. 3 illustrates the process of learning latent group segment disentanglement. For simplicity, it is shown how to learn two semantic segments, although the method can be extended to more segments. Formally, let gᵢ and gⱼ be two semantic segments in Z, where the goal is to make them independent of each other, e.g., gᵢ [symbol] gⱼ. To achieve this, the exemplary methods optimize each segment with two objectives to encourage the representations to be semantically independent.

First, the exemplary methods derive an ELBO objective for group segments. Following the evidence lower bound of the marginal likelihood in Eq. 6, the exemplary methods can get a similar form for group segments:

[symbol]

_{ELBO-G}(x)=−D_{KL}(q_{ϕ}_{ₘ}(gᵢ|x)∥p(gᵢ))−D_{KL}(q_{ϕ}_{ₙ}(gⱼ|x)∥p(gⱼ))+ [symbol] _{q}_{_{ϕm}}_{(g}_{ᵢ}_{,g}_{ⱼ}_{|x)} [log p_{θ}(x|gᵢ, gⱼ)]+αD_{KL}(q_{ϕ}(Z)∥p(Z)). 8)

which approximates the p(gᵢ) and p(gⱼ) from q_{ϕ}(gᵢ|x) and q^{ϕ}(gⱼ|x), respectively, fits the data distribution via reconstruction, maximizes MI between the latent and the input spaces, and where x is an input time series, Z is a latent variable, gᵢ and gⱼ are semantic segments in Z, q_{ϕ}(Z) is an aggregated posterior, D_{KL} is a decomposed KL term, α is a parameter that controls the importance of the dependency between z and x, p(Z) is a prior distribution, q_{ϕ}(z) is an amortized inference distribution, p(gᵢ) is a factorized prior distribution, and [symbol] _{q}_{_{ϕm}}q(gᵢ,gⱼ|x) is a posterior inference of a marginal likelihood of observed samples.

Second, the exemplary methods introduce auxiliary classification heads to encourage each segment to include only a single concept by leveraging the labeling function (e.g., the mapping to the ground truths) of each auxiliary task.

Formally, let fᵢ:Z→ [symbol] and fⱼ:Z→ [symbol] be the labeling functions of two auxiliary tasks that correspond to gᵢ and gⱼ, respectively. That is, fᵢ(Z_{g}) and fⱼ(Z_{g}) are the ground truths of the two tasks for gᵢ and gⱼ. The two classification heads aim to learn hypotheses hᵢ:Z→ [symbol] and hⱼ:Z→ [symbol] to approximate fᵢ and fⱼ, respectively. To optimize hᵢ and hⱼ, the exemplary methods can quantify the empirical error based on the following theorem.

For Theorem 1, for two independent group segments gᵢ and gⱼ, where gᵢ [symbol] gⱼ and Z_{g}={gᵢ, gⱼ}, the empirical error on the disentangled segments according to the distribution Z that a hypothesis h disagrees with a labeling function f is:

ϵ(h)=E_{g}_{ᵢ}_{˜} [symbol] [fᵢ(Z_{g})−hᵢ(gᵢ)]+E_{g}_{ⱼ}_{˜} [symbol] [fⱼ(Z_{g})−hⱼ(gⱼ)]

where ϵ(h) denotes the empirical error of DTS with respect to h.

With respect to the proof, since gᵢ [symbol] gⱼ, the exemplary methods can derive the empirical error as follows:

$$\begin{matrix}ϵ ( h ) = {E}_{( {g}_{i} , {g}_{j} ) ∼ 𝒵} [ f ( {Z}_{g} ) - h ( {Z}_{g} ) ] \\ = {E}_{{g}_{i} ∼ 𝒵} [ {f}_{i} ( {Z}_{g} ) - {h}_{i} ( {g}_{i} ) ] + {E}_{{g}_{j} ∼ 𝒵} [ {f}_{j} ( {Z}_{g} ) - {h}_{j} ( {g}_{j} ) ]\end{matrix}$$

Based on the independence property between gᵢ and gⱼ, the distribution of Z can be decomposed into two parts as to the error.

Following the above objectives, the exemplary methods can learn gᵢ and gⱼ, as follows. Let θᵢ and θⱼ be the parameters of the auxiliary classification heads for gᵢ and gⱼ, and θᵥₐₑ be the parameters of the VAE model. Assuming that P(gᵢ), P(gⱼ)˜ [symbol] (0, I) (which is a common assumption in generative models), the exemplary methods can apply a reparameterization trick by using sequential models (LSTMs or TCNs) as the universal approximator of q to encode the x into gᵢ and gⱼ, respectively. Then, the ELBO objective in equation (8) will be applied to learn disentangled group segments. Meanwhile, the exemplary methods can resort to auxiliary classification heads to make gᵢ task -j-invariant, and gⱼ task-i-invariant, as follows:

[symbol]

ᵢ(θᵥₐₑ, θᵢ, θⱼ)= [symbol] [hᵢ(gᵢ; θᵥₐₑ, θᵢ)−fᵢ(Z_{g})]−λ [symbol] [hⱼ(gᵢ; θᵥₐₑ, θⱼ)−fⱼ(Z_{g})]

[symbol]

ⱼ(θᵥₐₑ, θᵢ, θⱼ)= [symbol] [hⱼ(gⱼ; θᵥₐₑ, θⱼ)−fⱼ(Z_{g})]−λ [symbol] [hᵢ(gⱼ; θᵥₐₑ, θᵢ)−fᵢ(Z_{g})]. (9)

Specifically, the exemplary methods optimize the parameters \hat{θ}ᵥₐₑ, \hat{θ}ᵢ, \hat{θ}ⱼ based on: (\hat{θ}ᵥₐₑ, \hat{θ}ᵢ)=argmin_{θ}_{ᵥₐₑ}_{,θ}_{ᵢ}E(θᵢ, \hat{θ}ⱼ) and \hat{θ}ⱼ=argmax_{θ}_{ⱼ}E(\hat{θ}ᵥₐₑ, \hat{θ}ᵢ, \hat{θ}ⱼ), where the parameter λ controls the trade-off between the two objectives that shape the features during training. The update process is very similar to vanilla stochastic gradient descent updates for feedforward deep models. The λ factor tries to make disentangled features less discriminative for the irrelevant task. The exemplary methods use a gradient reversal layer (GRL) to exclude the discriminative information. During the forward propagation, GRL acts as an identity transform. During the backpropagation, GRL takes the gradient from the subsequent level, and multiplies the gradient by a negative constant, then passes it to the preceding layer.

To further illustrate the benefits of the proposed group segments disentanglement for time series, the exemplary methods apply it to solve the domain adaptation problem as a concrete application scenario. When labeled data is scarce for a specific target task, domain adaptation often offers an effective solution by utilizing data from a related source task from a transfer learning perspective. The hope is that this source domain is related to the target domain, and, thus, transferring knowledge from the source domain can improve the performance within the target domain. But “unrelated” features in the source samples can hurt the performance, leading to negative transfer.

Next, the negative transfer issue is addressed by disentangling the latent variables into grouped “class-dependent” segments that are domain invariant as transferable common knowledge and “domain-dependent” segments that may lead to negative transfer.

In the unsupervised domain adaptation problem, the exemplary methods use the labeled samples Dₛ={xᵢ^{S}, yᵢ^{S}}ᵢ₌₁ⁿ^{ₛ} on the source domain to classify the unlabeled samples {xⱼ^{T}}ⱼ₌₁ⁿ^{_{T}} on the target domain.

The exemplary methods aim to obtain two independent latent variables with disentanglement, including a domain-dependent latent variable g_{d} and a class-dependent latent variable g_{y}. These two variables are expected to encode the domain information and the class information, respectively. Then, the exemplary methods can use the class-dependent latent variable for classification since it is domain-invariant. Under the assumption that there exists some hypothesis h that performs well in both domains, it is shown that this quantity together with the empirical source error ϵ_{S}(h) characterize the target error ϵ_{T}(h), as described in Theorem 2.

Theorem 2 can be derived as follows:

For Theorem 2, it is assumed that the class factor g_{y} and the domain factor g_{d} are independent, e.g., g_{y} [symbol] g_{d}. Let Z_{g}={g_{y}, g_{d}}, and the error on the disentangled source and target domain with a hypothesis h is given as:

ϵ_{S}(h)= [symbol] [f_{y}(Z_{g})−h_{y}(g_{y})]+ [symbol] [f_{d}(Z_{g})−h_{d}(g_{d})]

ϵ_{T}(h)= [symbol] [f_{y}(Z_{g})−h_{y}(g_{y})]+ [symbol] [f_{d}(Z_{g})−h_{d}(g_{d})].

According to Theorem 2, the exemplary methods can find that the disentangled empirical classification error rate with respect to h in the source domain is lower than before disentanglement, e.g., (ϵ_{S}^{y}(h)=ϵ_{S}(h)−ϵ_{S}^{d}(h), where ϵ_{S}^{d}(h)≥0).

Thus, it is proved that the disentanglement of the representation space could be helpful and necessary for obtaining a lower classification error rate. The probabilistic bound on the performance ϵ_{T}(h) evaluated on the target domain given its performance ϵ_{S}(h) on the source domain can be defined as:

[symbol]

(h)≤ε_{S}(h)+1/2 [symbol] (S, [symbol] )+λ

where [symbol] measures the discrepancy distance between the source and target distribution with respect to hypothesis h, where λ does not depend on a particular h and is small enough to be a negligible term in the bound. The exemplary method provides a smaller discrepancy distance between two domains since it eliminates the discriminative information during the disentanglement. Thus, a tighter upper bound for the [symbol] (h) can be achieved through reducing [symbol] ( [symbol] , [symbol] ), which eventually leads to a better approximation of [symbol] (h).

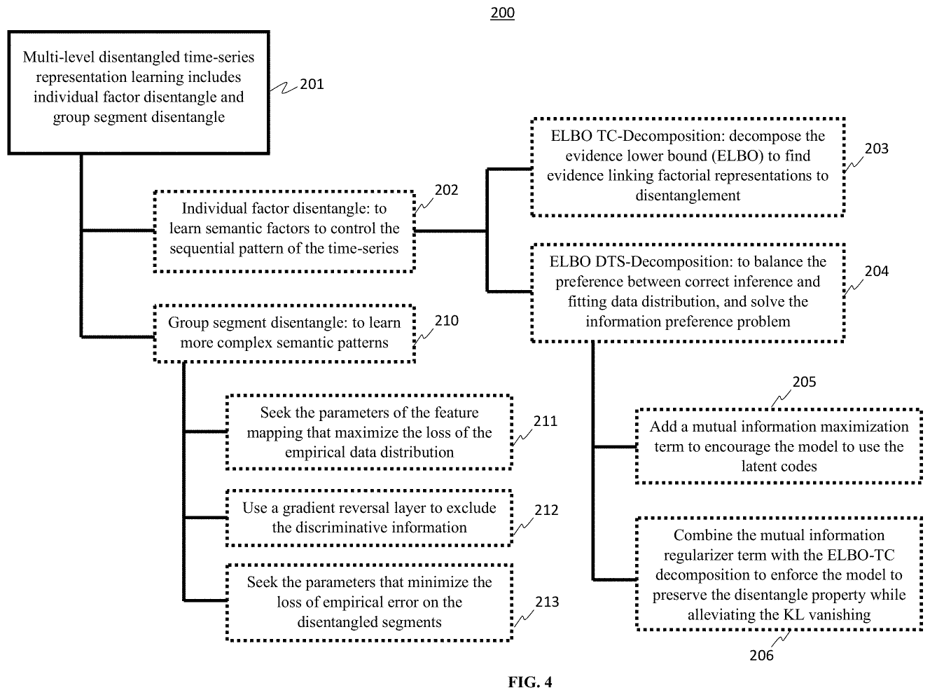

FIG. 4 is a block/flow diagram 200 of an exemplary schematic illustrating multi-level disentangled time-series representation learning including individual factor disentangle and group segment disentangle, in accordance with embodiments of the present invention.

At block 201, multi-level disentangled time-series representation learning includes individual factor disentangle and group segment disentangle.

At block 202, individual factor disentangle is employed to learn semantic factors to control the sequential pattern of the time-series.

At block 210, group segment disentangle is employed to learn more complex semantic patterns.

At block 203, the individual factor disentangle includes ELBO TC-Decomposition, that is, decomposing the evidence lower bound (ELBO) to find evidence linking factorial representations to disentanglement.

At block 204, the individual factor disentangle further includes ELBO DTS-Decomposition, that is, to balance the preference between correct inference and fitting data distribution, and solve the information preference problem.

Regarding the ELBO DTS-Decomposition, at block 205, add a mutual information maximization term to encourage the model to use the latent codes.

Regarding the ELBO DTS-Decomposition, at block 206, combine the mutual information regularizer term with the ELBO-TC decomposition to enforce the model to preserve the disentangle property while alleviating the KL vanishing.

Regarding the group segment disentangle, at block 211, seek the parameters of the feature mapping that maximize the loss of the empirical data distribution.

Regarding the group segment disentangle, at block 212, use a gradient reversal layer to exclude the discriminative information.

Regarding the group segment disentangle, at block 213, seek the parameters that minimize the loss of empirical error on the disentangled segments.

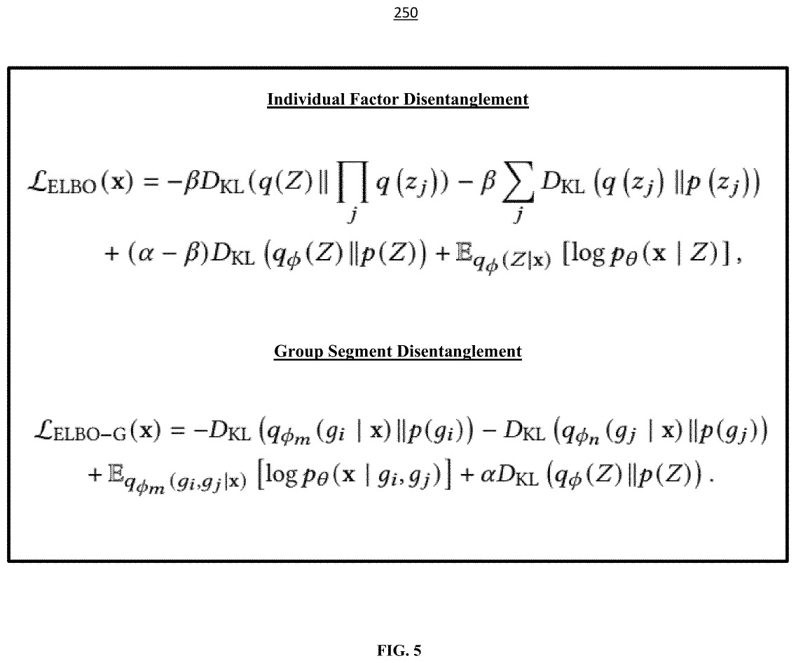

FIG. 5 is a block/flow diagram of exemplary equations for employing a deep unsupervised generative approach for disentangled factor learning, in accordance with embodiments of the present invention.

Equations 250 include ELBO for individual factor disentanglement and ELBO for group segment disentanglement.

In conclusion, the exemplary embodiments of the present invention introduce a deep unsupervised generative approach for disentangled factor learning, which automatically discovers the independent latent factors of variation in sequential data. A multi-level disentanglement strategy is designed by covering individual latent factors to group semantic segments, to generate hierarchical semantic concepts as interpretable and disentangled representations of time series. Furthermore, an ELBO decomposition strategy is introduced to weigh the preference between correct inference and the fitting data distribution problem.

Therefore, a novel disentanglement enhancement framework for time series data is presented. The exemplary approach achieves multi-level disentanglement by covering both individual latent factors and group semantic segments. The exemplary methods propose augmenting the original VAE objective by decomposing the evidence lower-bound and finding evidence linking factorial representations to disentanglement. Additionally, the exemplary methods introduce a mutual information maximization term between the observation space to the latent space to alleviate the KL vanishing problem while preserving the disentanglement property.

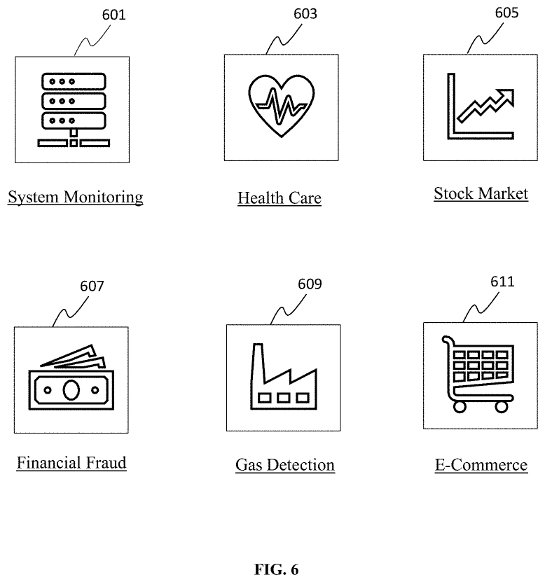

FIG. 6 is a block/flow diagram of an exemplary practical application for employing a deep unsupervised generative approach for disentangled factor learning, in accordance with embodiments of the present invention.

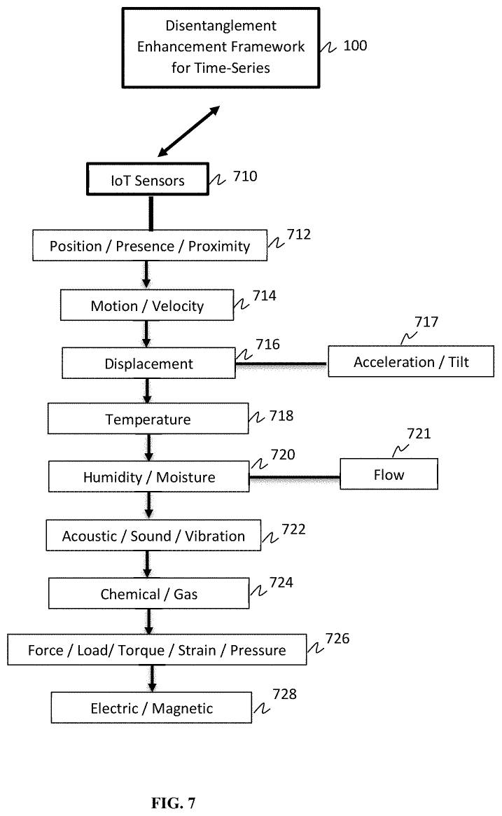

Practical applications for learning and forecasting trends in multivariate time series data can include, but are not limited to, system monitoring 601, healthcare 603, stock market data 605, financial fraud 607, gas detection 609, and e-commerce 611. The time-series data in such practical applications can be collected by sensors 710 (FIG. 7).

Therefore, in the absence of labeled data for a certain task, humans can effectively utilize prior experience and knowledge from a different domain, while artificial learners usually overfit without the necessary prior knowledge. In many applications, a model trained in one source domain performs poorly when applied to a target domain with different statistics due to domain shift. One of the main reasons is that domain-dependent and irrelevant information leads to negative transfer. If a human realizes that the current strategy fails in a new environment, he/she would try to update the strategy to be more context independent to maximize the use of existing resources and prior knowledge. Inspired from the human recognition and learning processes, artificial learning agents learn domain agnostic knowledge that is robust enough to change the domain and perform well in new arrival scenarios in practical applications 601, 603, 605, 607, 609, 611.

FIG. 7 is a block/flow diagram of exemplary Internet-of-Things (IoT) sensors used to collect data/information for employing a deep unsupervised generative approach for disentangled factor learning, in accordance with embodiments of the present invention.

IoT loses its distinction without sensors. IoT sensors act as defining instruments which transform IoT from a standard passive network of devices into an active system capable of real-world integration.

The IoT sensors 710 can communicate with the disentanglement enforcement framework 100 to process information/data, continuously and in real-time. Exemplary IoT sensors 710 can include, but are not limited to, position/presence/proximity sensors 712, motion/velocity sensors 714, displacement sensors 716, such as acceleration/tilt sensors 717, temperature sensors 718, humidity/moisture sensors 720, as well as flow sensors 721, acoustic/sound/vibration sensors 722, chemical/gas sensors 724, force/load/torque/strain/pressure sensors 726, and/or electric/magnetic sensors 728. One skilled in the art can contemplate using any combination of such sensors to collect data/information for input into the disentanglement enforcement framework 100 for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

Moreover data collection software can be used to manage sensing, measurements, light data filtering, light data security, and aggregation of data. Data collection software uses certain protocols to aid IoT sensors in connecting with real-time, machine-to-machine networks. Then the data collection software collects data from multiple devices and distributes it in accordance with settings. Data collection software also works in reverse by distributing data over devices. The system can eventually transmit all collected data to, e.g., a central server.

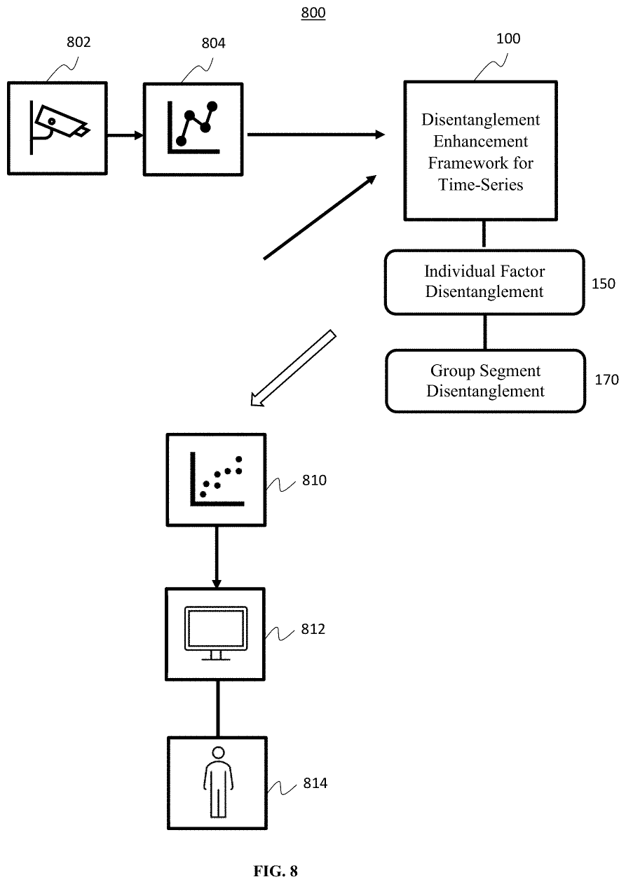

FIG. 8 is a block/flow diagram 800 of a practical application for employing a deep unsupervised generative approach for disentangled factor learning, in accordance with embodiments of the present invention.

In one practical example, a camera 802 can receive time series data 804. Features extracted from the time series data 804 are processed by the disentanglement enforcement framework 100 by employing an individual factor entanglement structure 150 and a group segment disentanglement structure 170. The results 810 (e.g., variables or parameters or factors) can be provided or displayed on a user interface 812 handled by a user 814.

Therefore, the DTS is a multi-level disentanglement approach, covering both individual latent factor and group semantic segments to generate hierarchical semantic concepts as the interpretable and disentangled representation. DTS can balance the preference between correct inference and fitting data distribution. DTS also alleviates the KL vanishing problem by introducing a mutual information maximization term while preserving a heavier penalty on the dimension-wise KL to keep the disentanglement property.

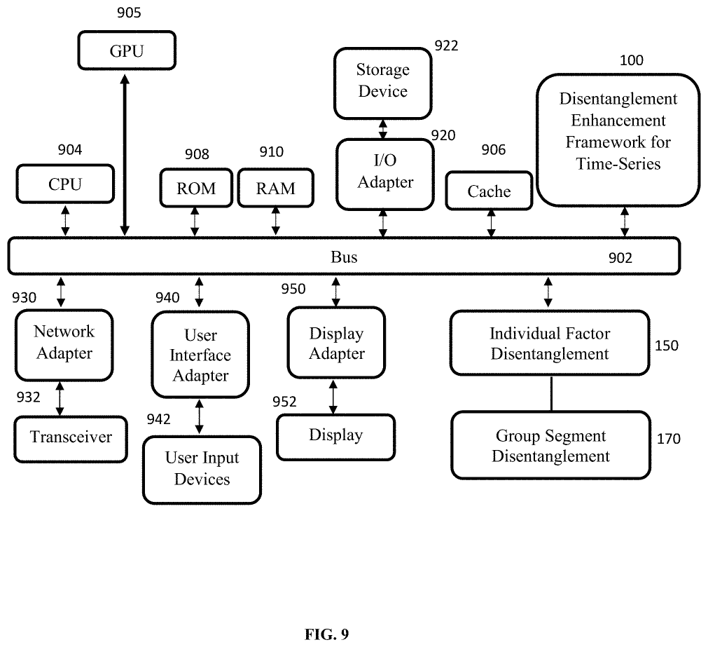

FIG. 9 is an exemplary processing system for employing a deep unsupervised generative approach for disentangled factor learning, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the disentanglement enforcement framework 100 can be employed by individual factor entanglement structure 150 and group segment entanglement structure 170.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

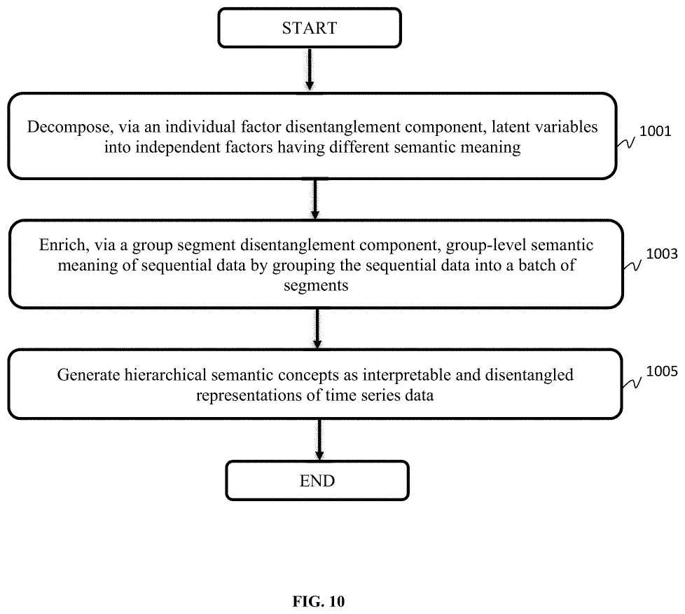

FIG. 10 is a block/flow diagram of an exemplary method for employing a deep unsupervised generative approach for disentangled factor learning, in accordance with embodiments of the present invention.

At block 1001, decompose, via an individual factor disentanglement component, latent variables into independent factors having different semantic meaning.

At block 1003, enrich, via a group segment disentanglement component, group-level semantic meaning of sequential data by grouping the sequential data into a batch of segments.

At block 1005, generate hierarchical semantic concepts as interpretable and disentangled representations of time series data.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for employing a deep unsupervised generative approach for disentangled factor learning, the method comprising:
decomposing, via an individual factor disentanglement component, latent variables into independent factors having different semantic meaning;
enriching, via a group segment disentanglement component, group-level semantic meaning of sequential data by grouping the sequential data into a batch of segments; and
generating hierarchical semantic concepts as interpretable and disentangled representations of time series data.

2. The method of claim 1, wherein lower bound decomposition is employed to provide for a balance between inference and data distribution fitting.

3. The method of claim 1, wherein a mutual information maximization term is provided to preserve correlation between the latent variables with an original times series.

4. The method of claim 1, wherein evidence lower bound (ELBO) for individual factor disentanglement is given as:
$${ℒ}_{ELBO} ( x ) = - β {D}_{KL} ( q ( Z ) ‖ {\prod }_{j} q ( {z}_{j} ) ) - β {\sum }_{j} {D}_{KL} ( q ( {z}_{j} ) ‖ p ( {z}_{j} ) ) + ( α - β ) {D}_{KL} ( {q}_{ϕ} ( Z ) ‖ p ( Z ) ) + {𝔼}_{{q}_{ϕ} ( Z \vert x )} [ log {p}_{θ} ( x \vert Z ) ] ,$$
where x is an input time series, β is a constraint, Z is a latent variable, zⱼ is a value of a latent variable, p_{θ}(x|Z) is a conditional probability of x that is parameterized by neural networks θ, q_{ϕ}(Z)= [symbol] ₚ_{_{θ(x)}}q(z|x) is an aggregated posterior, D_{KL} is a decomposed KL term, α is a parameter that controls an importance of the dependency between z and x, q(zⱼ) is a factorized posterior that captures an aggregate structure of the latent variables, p(zⱼ) is a factorized prior distribution, p(Z) is a prior distribution, and q(Z) is the aggregated posterior that captures an aggregate structure of the latent variables.

5. The method of claim 1, wherein evidence lower bound (ELBO) for group segment disentanglement is given as: [symbol]
_{ELBO-G}(x)=−D_{KL}(q_{ϕ}_{ₘ}(gᵢ|x)∥p(gᵢ))−D_{KL}(q_{ϕ}_{ₙ}(gⱼ|x)∥p(gⱼ))+ [symbol] _{q}_{_{ϕm}}_{(g}_{ᵢ}_{,g}_{ⱼ}_{|x)} [log p_{θ}(x|gᵢ, gⱼ)]+αD_{KL}(q_{ϕ}( [symbol] )∥p( [symbol] ))
where x is an input time series, Z is a latent variable, gᵢ and gⱼ are semantic segments in Z, q_{ϕ}(Z) is an aggregated posterior, D_{KL} is a decomposed KL term, α is a parameter that controls the importance of the dependency between z and x, p(Z) is a prior distribution, q_{ϕ}(z) is an amortized inference distribution, p(gᵢ) is a factorized prior distribution, and [symbol] _{q}_{_{ϕm}}q(gᵢ, gⱼ|x) is a posterior inference of a marginal likelihood of observed samples.

6. The method of claim 1, wherein each segment of the batch of segments is optimized with two objectives to encourage the representations to be semantically independent.

7. The method of claim 1, wherein auxiliary classification heads are employed to encourage each segment of the batch of segments to include only a single concept by leveraging a labeling function of each auxiliary task.

8. A non-transitory computer-readable storage medium comprising a computer-readable program for employing a deep unsupervised generative approach for disentangled factor learning, wherein the computer-readable program when executed on a computer causes the computer to perform the steps of:
decomposing, via an individual factor disentanglement component, latent variables into independent factors having different semantic meaning;
enriching, via a group segment disentanglement component, group-level semantic meaning of sequential data by grouping the sequential data into a batch of segments; and
generating hierarchical semantic concepts as interpretable and disentangled representations of time series data.

9. The non-transitory computer-readable storage medium of claim 8, wherein lower bound decomposition is employed to provide for a balance between inference and data distribution fitting.

10. The non-transitory computer-readable storage medium of claim 8, wherein a mutual information maximization term is provided to preserve correlation between the latent variables with an original times series.

11. The non-transitory computer-readable storage medium of claim 8, wherein evidence lower bound (ELBO) for individual factor disentanglement is given as:
$${ℒ}_{ELBO} ( x ) = - β {D}_{KL} ( q ( Z ) ‖ {\prod }_{j} q ( {z}_{j} ) ) - β {\sum }_{j} {D}_{KL} ( q ( {z}_{j} ) ‖ p ( {z}_{j} ) ) + ( α - β ) {D}_{KL} ( {q}_{ϕ} ( Z ) ‖ p ( Z ) ) + {𝔼}_{{q}_{ϕ} ( Z \vert x )} [ log {p}_{θ} ( x \vert Z ) ] ,$$
where x is an input time series, β is a constraint, Z is a latent variable, zⱼ is a value of a latent variable, p_{θ}(x|Z) is a conditional probability of x that is parameterized by neural networks θ, q_{ϕ}(Z)= [symbol] ₚ_{_{θ(x)}}q(z|x) is an aggregated posterior, D_{KL} is a decomposed KL term, α is a parameter that controls an importance of the dependency between z and x, q(zⱼ) is a factorized posterior that captures an aggregate structure of the latent variables, p(zⱼ) is a factorized prior distribution, p(Z) is a prior distribution, and q(Z) is the aggregated posterior that captures an aggregate structure of the latent variables.

12. The non-transitory computer-readable storage medium of claim 8, wherein evidence lower bound (ELBO) for group segment disentanglement is given as: [symbol]
_{ELBO-G}(x)=−D_{KL}(q_{ϕ}_{ₘ}(gᵢ|x)∥p(gᵢ))−D_{KL}(q_{ϕ}_{ₙ}(gⱼ|x)∥p(gⱼ))+ [symbol] _{q}_{_{ϕm}}_{(g}_{ᵢ}_{,g}_{ⱼ}_{|x)} [log p_{θ}(x|gᵢ, gⱼ)]+αD_{KL}(q_{ϕ}(Z)∥p(Z))
where x is an input time series, Z is a latent variable, gᵢ and gⱼ are semantic segments in Z, q_{ϕ}(Z) is an aggregated posterior, D_{KL} is a decomposed KL term, α is a parameter that controls the importance of the dependency between z and x, p(Z) is a prior distribution, q_{ϕ}(z) is an amortized inference distribution, p(gᵢ) is a factorized prior distribution, and [symbol] _{q}_{_{ϕm}}q(gᵢ, gⱼ|x) is a posterior inference of a marginal likelihood of observed samples.

13. The non-transitory computer-readable storage medium of claim 8, wherein each segment of the batch of segments is optimized with two objectives to encourage the representations to be semantically independent.

14. The non-transitory computer-readable storage medium of claim 8, wherein auxiliary classification heads are employed to encourage each segment of the batch of segments to include only a single concept by leveraging a labeling function of each auxiliary task.

15. A system for employing a deep unsupervised generative approach for disentangled factor learning, the system comprising:
a memory; and
one or more processors in communication with the memory configured to:
decompose, via an individual factor disentanglement component, latent variables into independent factors having different semantic meaning;
enrich, via a group segment disentanglement component, group-level semantic meaning of sequential data by grouping the sequential data into a batch of segments; and
generate hierarchical semantic concepts as interpretable and disentangled representations of time series data.

16. The system of claim 15, wherein lower bound decomposition is employed to provide for a balance between inference and data distribution fitting.

17. The system of claim 15, wherein a mutual information maximization term is provided to preserve correlation between the latent variables with an original times series.

18. The system of claim 15, wherein evidence lower bound (ELBO) for individual factor disentanglement is given as:
$${ℒ}_{ELBO} ( x ) = - β {D}_{KL} ( q ( Z ) ‖ {\prod }_{j} q ( {z}_{j} ) ) - β {\sum }_{j} {D}_{KL} ( q ( {z}_{j} ) ‖ p ( {z}_{j} ) ) + ( α - β ) {D}_{KL} ( {q}_{ϕ} ( Z ) ‖ p ( Z ) ) + {𝔼}_{{q}_{ϕ} ( Z \vert x )} [ log {p}_{θ} ( x \vert Z ) ] ,$$
where x is an input time series, β is a constraint, Z is a latent variable, zⱼ is a value of a latent variable, p_{θ}(x|Z) is a conditional probability of x that is parameterized by neural networks θ, q_{ϕ}(Z)= [symbol] ₚ_{_{θ(x)}}(z|x) is an aggregated posterior, D_{KL} is a decomposed KL term, α is a parameter that controls an importance of the dependency between z and x, q(zⱼ) is a factorized posterior that captures an aggregate structure of the latent variables, p(zⱼ) is a factorized prior distribution, p(Z) is a prior distribution, and q(Z) is the aggregated posterior that captures an aggregate structure of the latent variables.

19. The system of claim 15, wherein evidence lower bound (ELBO) for group segment disentanglement is given as: [symbol]
_{ELBO-G}(x)=−D_{KL}(q_{ϕ}_{ₘ}(gᵢ|x)∥p(gᵢ))−D_{KL}(q_{ϕ}_{ₙ}(gⱼ|x)∥p(gⱼ))+ [symbol] _{q}_{_{ϕm}}_{(g}_{ᵢ}_{,g}_{ⱼ}_{|x)} [log p_{θ}(x|gᵢ, gⱼ)]+αD_{KL}(q_{ϕ}(Z)∥p(Z))
where x is an input time series, Z is a latent variable, gᵢ and gⱼ are semantic segments in Z, q_{ϕ}(Z) is an aggregated posterior, D_{KL} is a decomposed KL term, α is a parameter that controls the importance of the dependency between z and x, p(Z) is a prior distribution, q_{ϕ}(z) is an amortized inference distribution, p(gᵢ) is a factorized prior distribution, and [symbol] _{q}_{_{ϕm}}q(gᵢ, gⱼ|x) is a posterior inference of a marginal likelihood of observed samples.

20. The system of claim 15,
wherein each segment of the batch of segments is optimized with two objectives to encourage the representations to be semantically independent; and
wherein auxiliary classification heads are employed to encourage each segment of the batch of segments to include only a single concept by leveraging a labeling function of each auxiliary task.
